(19) United States
(12) Patent Application Publication
(10) Pub. No.: US 2014/0029971 A1
(43) Pub. Date: Jan. 30, 2014

(54) SEALING DEVICE INCLUDING A FIRST REPLACEABLE COMPLIANT SEALING MEMBER AND A LATCH MEMBER

(71) Applicants: James Pingel, San Diego, CA (US); David Sabo, San Diego, CA (US); Christopher S. Tanner, San Diego, CA (US)

(72) Inventors: James Pingel, San Diego, CA (US); David Sabo, San Diego, CA (US); Christopher S. Tanner, San Diego, CA (US)

(21) Appl. No.: 13/560,481

(22) Filed: Jul. 27, 2012

(51) Int. Cl. G03G 15/08

(52) U.S. Cl. 399/103

(57) ABSTRACT

A sealing device usable with an ink developer unit including a plurality of rollers and a plurality of end cap members includes a first replaceable compliant sealing member and a latch member. The first replaceable compliant sealing member has a plurality of replaceable seal exterior surfaces to form a seal between a first set of rollers of the plurality of rollers and one of the end cap members. The latch member has a closed state to maintain a sealing force on the first replaceable compliant sealing member and an open state to remove the sealing force on the first replaceable complaint sealing member.

### BACKGROUND

Ink developer units are used in image forming apparatuses to supply ink to a photoconductive drum to form images on substrates. Ink developer units include sealing devices to prevent ink from leaking out of the ink developer units.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 is a schematic view illustrating an image forming apparatus having an ink developer unit including a sealing device according to an example.

FIG. 2A is a cross-sectional view illustrating the ink developer unit of FIG. 1 according to an example. FIG. 2B is a schematic view illustrating the ink developer unit of FIG. 2A according to an example.

FIG. 3 is a block diagram illustrating the ink developer unit of FIG. 1 according to an example.

FIG. 4 is a block diagram illustrating a sealing device usable with an ink developer unit including a plurality of rollers and a plurality of end cap members according to an example.

FIG. 5 is a schematic view illustrating a portion of an ink developer unit including the sealing device of FIG. 4 according to an example.

FIG. 6 is a schematic view illustrating a latch member of the sealing device of FIG. 1 according to an example.

FIG. 7 is a schematic view illustrating a first replaceable compliant sealing member of the sealing device of FIG. 4 according to an example.

FIG. 8 is a schematic view illustrating a second compliant sealing member of the sealing device of FIG. 4 according to an example.

### DETAILED DESCRIPTION

In the following detailed description, reference is made to the accompanying drawings which form a part hereof, and in which is detected by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Sealing devices may be used in ink developer units. Ink developer units such as binary ink developers (BIDS) may be used in image forming apparatuses such as liquid electrophotography printers (LEP) and include rollers to supply ink to a photoconductive drum to form images on substrate. The sealing devices, for example, may be disposed on side surfaces of one or more rollers through an interference fit to prevent ink from leaking out of the ink developer units. The sealing device may incur compression set based on its contact, for example, with a developer roller of an ink developer unit. Consequently, upon replacement of the developer roller, the existing sealing device may not provide a sufficient seal therewith. Additionally, the sealing devices may require stringent manufacturing tolerances and have low durability. Variation of the respective tolerances may result in adverse conditions such as a premature wear condition, a product failure condition, an ink splatter condition, an ink overflow condition, a fused ink condition, and the like.

In examples, a sealing device may be used with an ink developer unit including a plurality of rollers and a plurality of end cap members. The sealing device may include a first replaceable compliant sealing member and a latch member. The first replaceable compliant sealing member may have a plurality of replaceable seal exterior surfaces to form a seal between a first set of rollers of the plurality of rollers and one of the end cap members. The latch member may also have a closed state to maintain a sealing force on the first replaceable compliant sealing member and an open state to remove the sealing force on the first replaceable complaint sealing member. Consequently, upon replacement of the developer roller, the first replaceable compliant member may also be replaced to provide a sufficient seal therewith. Further, the use of a first replaceable compliant sealing member in addition to a second compliant sealing member may enable a wider seal between the first replaceable compliant sealing member and the developer roller to lower the sealing temperature. Accordingly, the sealing device of the present disclosure may require less-stringent manufacturing tolerances, have high durability, and/or include replaceable portions thereof. Thus, the sealing device of the present disclosure may reduce occurrences of a premature wear condition, a product failure condition, an ink splatter condition, an ink overflow condition, a fused ink condition, and the like. Additionally, the sealing device may reduce the need to replace the ink developer unit due to wear of a sealing device therein.

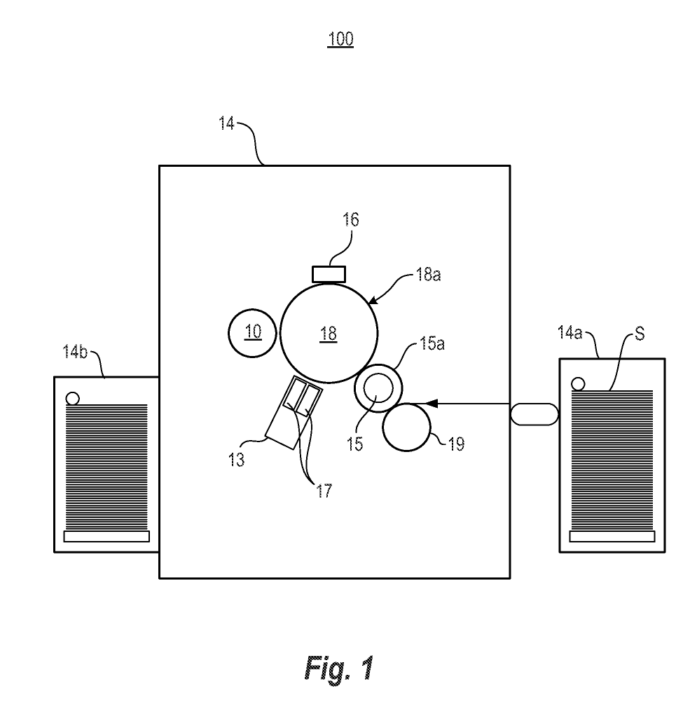

FIG. 1 is a schematic view illustrating an image forming apparatus having an ink developer unit including a sealing device according to an example. Referring to FIG. 1, an image forming system 100 such as an LEP includes an image forming assembly 14 that receives substrate S from an input unit 14a and outputs the substrate S to an output unit 14b. The image forming assembly 14 includes an ink developer unit 13 and a photoconductive member 18 on which images can be formed. In some examples, the image forming apparatus 100 may include a plurality of ink developer units 13. The photoconductive member 18 may include an outer surface 18a to be charged with a charging member 10 such as a charge roller, and the like. The charge of selected portions of the outer surface 18a of the photoconductive member 18 that correspond to features of the image can be selectively changed by an imaging member 16 such as a laser writing unit, and the like, to form a latent image thereon. That is, the imaging member 16 may increase or decrease an amount of charge on selected portions of the outer surface 18a of the photoconductive member 18 to form a latent image thereon.

Referring to FIG. 1, in some examples, an ink developer unit 13 such as binary ink developers may apply the fluid such as liquid toner to the latent image on the outer surface 18a of the photoconductive member 18 to form an image to be transferred to an intermediate transfer member (TM) 15 that may include a blanket 15a thereon. The ink develop unit 13, for example, may include a sealing device 17 to reduce unwanted ink from leaking out of the ink developer unit 13. In some examples, each ink developer unit 13 may include a pair of sealing devices 17. Subsequently, the ITM 15 may transfer the image to the substrate S. During the transfer of the image from the blanket 15a of the ITM 15 to the substrate S, the substrate S may be pinched between the ITM 15 and an impression member 19. Once the image has been transferred to the substrate S, the substrate S may be transported to the output unit 14b.

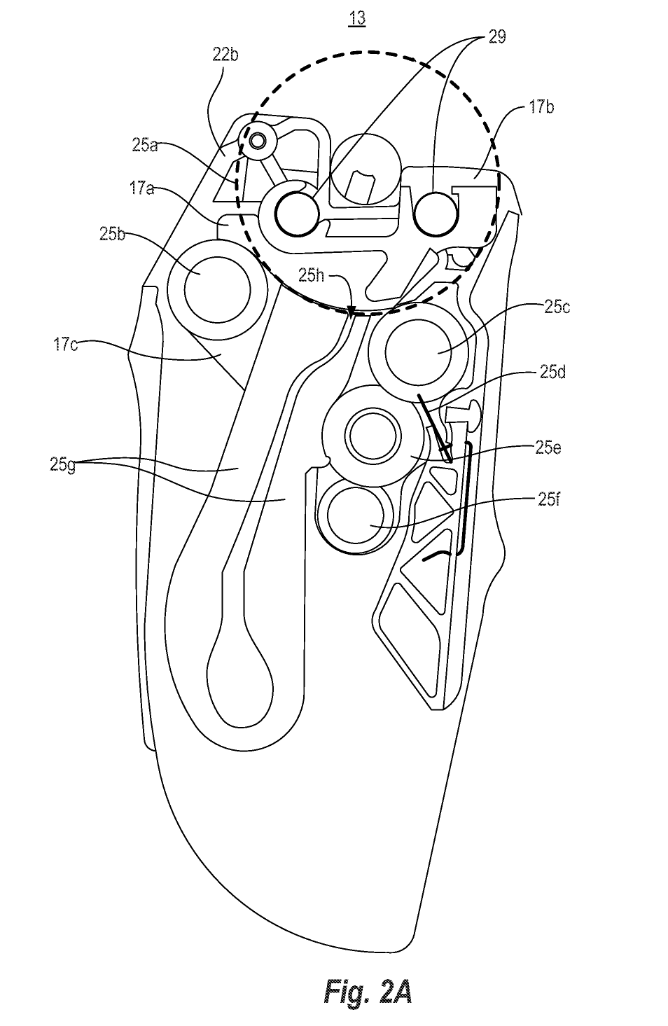

FIG. 2A is a cross-sectional view illustrating the ink developer unit of FIG. 1 according to an example. FIG. 2B is a schematic view of the ink developer unit of FIG. 2A according to an example. Referring to FIGS. 2A and 2B, in some examples, an ink developer unit 13 such as a BID may include a housing unit 21 and end cap members 22a and 22b. The ink developer unit 13 may removably engage with a photoconductive drum 18 (FIG. 1) of an image forming apparatus 100 such as an LEP. The housing unit 21 may include a developer roller 25a, a squeegee roller 25b, a cleaner roller 25c, a wiper blade 25d, a sponge roller 25e, a squeezer roller 25f, a pair of electrodes 25g, a channel 25h, and at least one sealing device 17. In an example, the pair of electrodes 25g may form the channel 25h or a portion thereof. The at least one sealing member 17 may include a first replaceable compliant sealing member 17a, a latch member 17h, and a second compliant sealing member 17c. In some examples, the ink developer unit 13 may include a pair of sealing devices 17.

Referring to FIGS. 2A and 2B, in some examples, the ink developer unit 13 may provide a uniform film of ink such as liquid toner to a photoconductive drum 18. The developer roller 25a may supply a film of the ink to be selectively transferred to the photoconductive drum 18. For example, the developer roller 25a may rotate through a flow of the ink to adhere ink thereto. The developer roller 25a may be a replaceable developer roller. That is, the developer roller 25a may be replaced within the housing unit 21 of the ink developer unit 13 when needed. The pair of electrodes 25g and the developer roller 25a may be electrically charged to manipulate, for example, ink particles onto the developer roller 25a. The channel 25h disposed within the housing unit 21 may provide ink to the developer roller 25a. The squeegee roller 25b may compact the ink on the developer roller 25a to form a uniform layer thereon. The sponge roller 25e may contact and clean the wiper 25d. The squeezer roller 25f may contact and clean the sponge roller 25e.

Ink on the developer roller 25a may be attracted and transferred to the charged portions of the photoconductive drum 18. The charged portions may correspond to an image to be printed. The image in the form of ink may be subsequently transferred to a substrate S either directly or through an ITM 15 (FIG. 1). The cleaner roller 25c may remove access ink remaining on the developer roller 25a and not previously transferred to the photoconductive drum 18. In some examples, the wiper blade 25d may scrape excess ink from the cleaner roller 25c. The end cap members 22a and 22b may rotatably support at least one roller of the plurality of rollers 25 such as the developer roller 25a, and the like. For example, the housing unit 21 may include a pair of end cap members 22a and 22b to support each end of the developer roller 25a. In some examples, the end cap members 22a and 22b may include support members 29 such as cylindrical members to engage the latch member 17b.

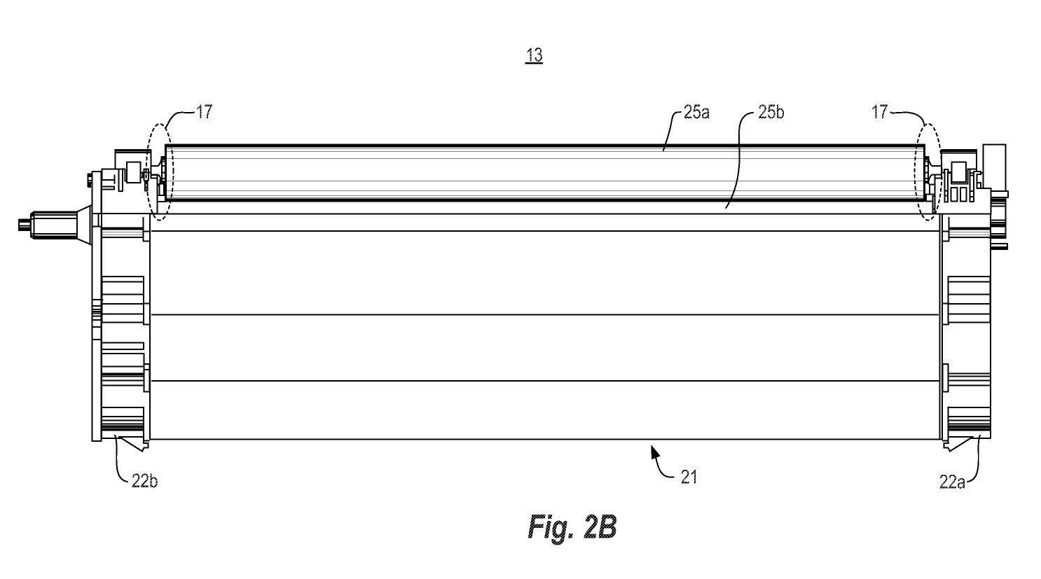

FIG. 3 is a block diagram illustrating the ink developer unit of FIG. 1 according to an example. Referring to FIG. 3, in some examples, an ink developer unit 13 includes a housing unit 21, a plurality of rollers 25 rotatably attached to the housing unit 21, a plurality of end cap members 22a and 22b (collectively 22) of the housing unit 21 to support at least one roller of the plurality of rollers 25a, 25b, 25c, 25e and 25f (collectively 25), and at least one sealing device 17 disposed within the housing unit 21 in an installed state. The at least one sealing device 17 may include a first replaceable compliant sealing member 17a, a latch member 17b, and a second compliant sealing member 17c. In some examples, the first replaceable compliant sealing member 17a and the second compliant sealing member 17c may also include closed cell foam.

Referring to FIG. 3, in some examples, the first replaceable compliant sealing member 17a may have a plurality of replaceable seal exterior surfaces 37a to form a seal between a first set of rollers of the plurality of rollers 25 and one of the end cap members 22a. The seal may be formed by the replaceable seal exterior surfaces 37a of the first replaceable compliant sealing member 17a and may limit an unwanted flow of ink from inside to outside of the ink developer unit 13 such as the housing unit 21. The latch member 17b may have a closed state to maintain a sealing force on the first replaceable compliant sealing member 17a and an open state to remove the sealing force on the first replaceable complaint sealing member 17a. The second compliant sealing member 17c may have a plurality of seal exterior surfaces 37c to form a seal between a second set of rollers of the plurality of rollers 25 and the one of the end cap members 22a. The seal formed by the seal exterior surfaces 37c of the second compliant sealing member 17c may limit the unwanted flow of ink from the inside to the outside of the ink developer unit 13 such as the housing unit 21. In some examples, the at least one sealing device 17 comprises a pair of sealing devices.

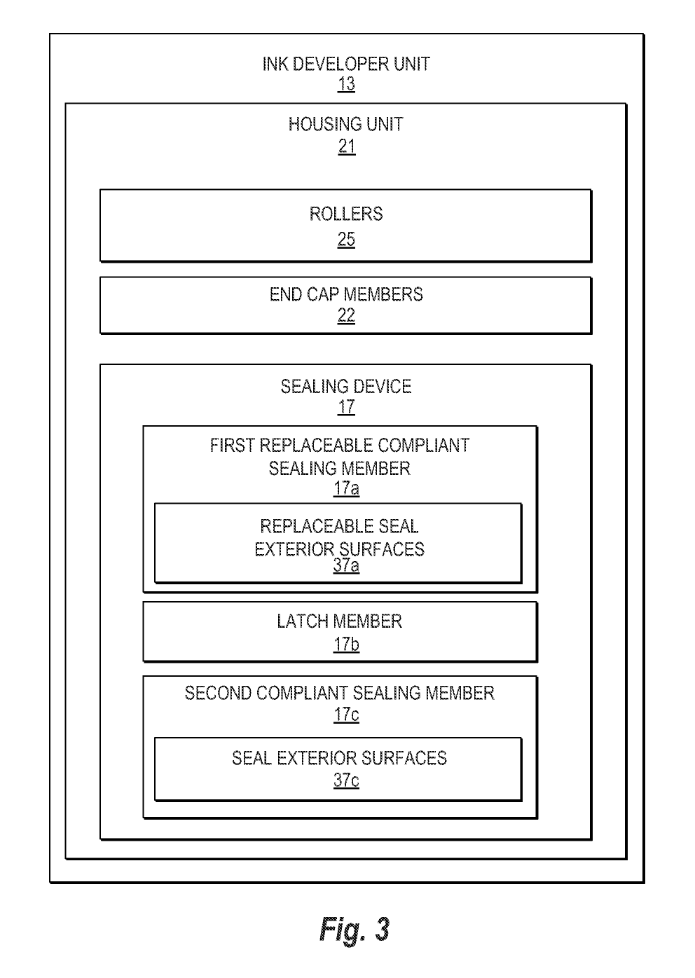

FIG. 4 is a block diagram illustrating a sealing device usable with an ink developer unit including a plurality of rollers and a plurality of end cap members according to an example. Referring to FIGS. 3 and 4, in some examples, a sealing device 17 is usable with an ink developer unit including a plurality of rollers 25 and a plurality of end cap members 22a and 22b (collectively 22). The sealing device 17 may include a first replaceable compliant sealing member 17a and a latch member 17b. The first replaceable compliant sealing member 17a having a plurality of replaceable seal exterior surfaces 37a to form a seal between a first set of rollers of the plurality of rollers 25 and one of the end cap members 22a. The latch member 17b may have a closed state to maintain a sealing force on the first replaceable compliant sealing member 17a and an open state to remove the sealing force on the first replaceable complaint sealing member 17a.

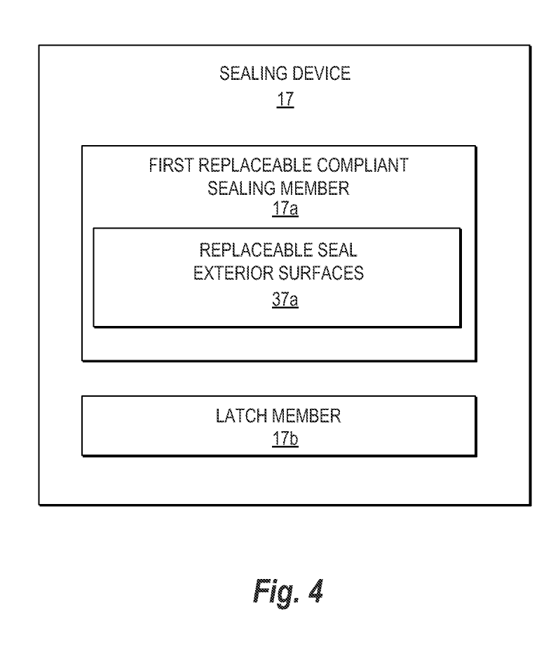

FIG. 5 is a schematic view illustrating a portion of an ink developer unit including the sealing device of FIG. 4 according to an example. Referring to FIG. 5, in some examples, a sealing device 17 may include the first replaceable compliant sealing member 17a and the latch member 17b as previously disclosed with respect to FIG. 4. As illustrated in FIG. 5, in some examples, the sealing device 17 may also include a second compliant sealing member 17c having a plurality of seal exterior surfaces to form a seal between a second set of rollers of the plurality of rollers 25 and the one of the end cap members 22a. The first set of rollers may include a developer roller 25a, a squeegee roller 25b, and a cleaner roller 25c. The replaceable seal exterior surfaces of the first replaceable compliant sealing member 17a may contact the developer roller 25a, the squeegee roller 25b, the cleaner roller 25c, and the one of the end cap members 22a. The developer roller 25a may supply a film of ink to be selectively transferred to a photoconductive drum 18. The developer roller 18 may include a replaceable developer roller. The squeegee roller 25b may compact the ink on the developer roller 25a to form a uniform layer thereon. The cleaner roller 25c may remove access ink remaining on the developer roller 25a and not previously transferred to the photoconductive drum 18.

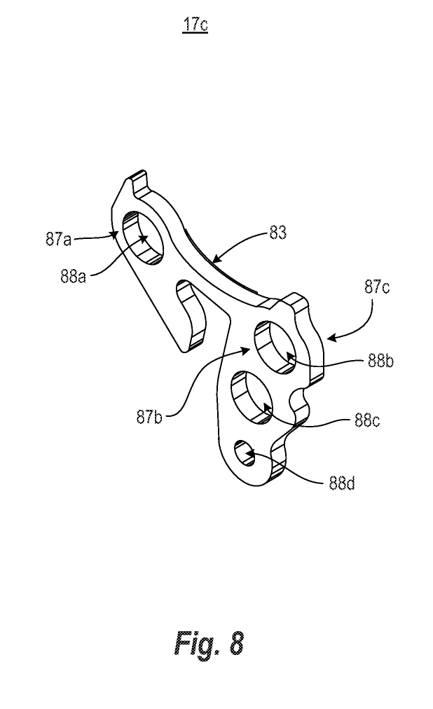

In some examples, the second set of rollers may include the squeegee roller 25b and the cleaner roller 25c. The seal exterior surfaces of the second compliant sealing member 17c may contact the squeegee roller 25b, the cleaner roller 25c, and the one of the end cap members 22a. The first replaceable compliant sealing member 17a and the second compliant sealing member 17c may also include dosed cell foam. In some examples, the ink developer unit 13 may also include an adhesive 83 (FIG. 8) and a channel 25h. The adhesive 83 may be in contact with the housing unit 21 such as one of the end cap members 22a and a third seal exterior portion 87c of the seal exterior surfaces of the second compliant sealing member 17c. The adhesive 83 may couple the second complaint sealing member 17c to the housing unit 21. The channel 25h may be disposed within the housing unit 21 to provide ink to one roller of the plurality of rollers 25 such as the developer roller 25a.

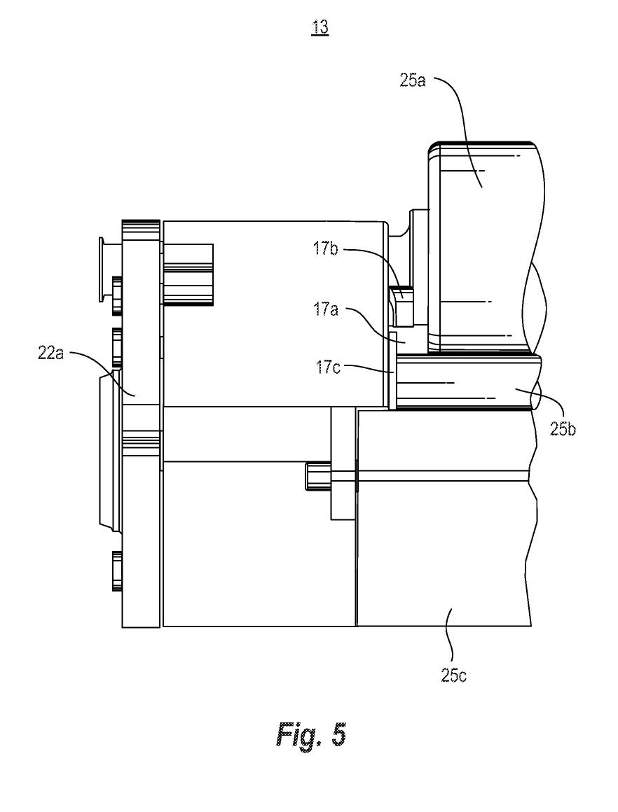

FIG. 6 is a schematic view illustrating a latch member of the sealing device of FIG. 1 according to an example. Referring to FIGS. 5 and 6, in some examples, a latch member 17b may include a cam portion 67a, a friction portion 67b, support engagement portions 67c, and sealing member contact portion 67d. The cam portion 67a may maintain a sealing force on the first replaceable compliant sealing member 17a in the closed state and remove the sealing force on the first replaceable complaint sealing member 17a in the open state. For example, a cam surface may be disposed at a pivot location of the latch member 17b. As the latch member 17b is placed in the closed state, the cam surface may compress the first replaceable compliant sealing member 17a against the squeegee roller 25b to form a seal. When the latch member 17b is moved to the open state, the cam surface may lose contact with the first replaceable compliant sealing member 17a to allow easy removal and installation by reducing and/or eliminating compression there between.

Referring to FIG. 6, in some examples, the friction portion 67b including barbed teeth to engage a first replaceable seal exterior portion 77a of the replaceable seal exterior surfaces of the first replaceable compliant sealing member 17a in the closed state. In some examples, the cam portion 67a and friction portion 67b may constrain the first replaceable compliant sealing member 17a and apply a sealing force, for example, toward a squeegee nip when the latch member 17b is in the closed portion. In the open state, a sealing force is retracted to allow easy replacement of the first replaceable compliant sealing member 17a. The support engagement portions 67c may engage support members 29 (FIG. 2A), for example, extending from the housing unit 21 and/or end cap members 22a and 22b. The sealing member contact portion 67d may contact the fourth replaceable seal exterior portion 77d of the first replaceable compliant sealing member 17a in the closed state.

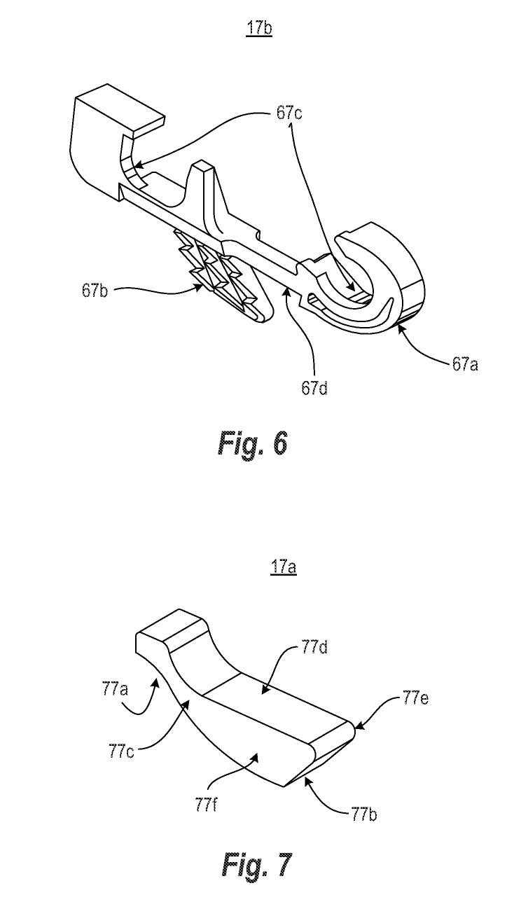

FIG. 7 is a schematic view illustrating a first replaceable compliant sealing member of the sealing device of FIG. 4 according to an example. Referring to FIGS. 5 and 7, in some examples, a first replaceable compliant sealing member 17a may include a plurality of replaceable seal exterior surfaces. For example, the replaceable seal exterior surfaces may include a first replaceable seal exterior portion 77a, a second replaceable seal exterior portion 77b, a third replaceable seal exterior portion 77c, a fourth replaceable seal exterior portion 77d, and a fifth replaceable seal exterior portion 77e. The first replaceable seal exterior portion 77a may contact and form a seal with a circumference surface of the squeegee roller 25b. The second replaceable seal exterior portion 77b may tangentially contact and form a seal with a circumference surface of the cleaner roller 25c.

Referring to FIG. 7, in some examples, the third replaceable seal exterior portion 77c may contact and form a seal with a face surface of the developer roller 25a. The fourth replaceable seal exterior portion 77d may receive and contact the latch member 17b. The fifth replaceable seal exterior portion 77e may contact one of the end cap members 22a. The sixth replaceable seal exterior portion 77f receive and contact the friction portion 67b of the latch member 17b. In some examples, rotation from the developer roller 25a and cleaner roller 25c may reduce ink accumulation on a respective seal.

FIG. 8 is a schematic view illustrating a second compliant sealing member of the sealing device of FIG, 4 according to an example. Referring to FIGS. 5 and 8, in some examples, a second compliant sealing member 17c may include a plurality of openings 88a, 88b, 88c, and 88d and a plurality of seal exterior surfaces. A first opening 88a may provide clearance for a squeegee roller 25b, for example, to access dynamic seals and bearings, a second opening 88b may provide clearance for a cleaner roller 25c to access dynamic seals and bearings, a third opening 88c may provide clearance for a sponge roller 25e to access dynamic seals and bearings, and a fourth opening 88d may provide clearance for a squeezer roller 25f to access dynamic seals and bearings.

In some examples, in operation, seal exterior surfaces of the second compliant sealing member 17c may form a seal between the squeegee roller 25b and the cleaner roller 25c and the one of the end cap members 22a. For example, a face surface of the squeegee roller 25b may compress a first seal exterior portion 87a of the seal exterior surfaces and a face surface of the cleaner roller 25c may compress a second seal exterior portion 87b of the seal exterior surfaces of the second compliant sealing member 17c. Additionally, the one end cap member 22a may contact and form a seal with a third seal exterior portion 87c of the seal exterior surfaces of the second compliant sealing member 170. In some examples, the second compliant sealing member 17c may be compressed between the face surface of the squeegee roller 25b, the face surface of the cleaner roller 25c and one of the end cap members 22a to allow the respective rollers to float and maintain nips between respective rollers.

The present disclosure has been described using non-limiting detailed descriptions of examples thereof. Such examples are not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may describe examples contemplated by the inventors and therefore may include structure, acts or details of structures and acts that may not be essential to the present disclosure and which are described as examples. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A sealing device usable with an ink developer unit including a plurality of rollers and a plurality of end cap members, the sealing device comprising:
a first replaceable compliant sealing member having a plurality of replaceable seal exterior surfaces to form a seal between a first set of ropers of the plurality of rollers and one of the end cap members; and
a latch member having a closed state to maintain a sealing force on the first replaceable compliant sealing member and an open state to remove the sealing force on the first replaceable complaint sealing member.

2. The sealing device according to claim 1, further comprising:
a second compliant sealing member having a plurality of seal exterior surfaces to form a seal between a second set of rollers of the plurality of rollers and the one of the end cap members.

3. The sealing device according to claim 2, wherein the first set of rollers includes:
a developer roller configured to supply a film of ink to be selectively transferred to a photoconductive drum;
a squeegee roller configured to compact the ink on the developer roller to form a uniform layer thereon; and
a cleaner roller configured to remove access ink remaining on the developer roller and not previously transferred to the photoconductive drum; and
wherein the second set of rollers includes the squeegee roller and the cleaner roller.

4. The sealing device according to claim 3, wherein the second set of rollers comprises the squeegee roller and the cleaner roller.

5. The sealing device according to claim 1, wherein the first replaceable compliant sealing member further comprises closed cell foam.

6. The sealing device according to claim 1, wherein he latch member further comprises:
a cam portion to maintain a sealing force on the first replaceable compliant sealing member in the closed state and to remove the sealing force on the first replaceable complaint sealing member in the open state.

7. The sealing device according to claim 6, wherein the latch member further comprises:
a friction portion including barbed teeth to engage a portion of the plurality of the replaceable seal exterior surfaces of the first replaceable compliant sealing member in the closed state.

8. The sealing device according to claim 2, wherein the second replaceable compliant sealing member further comprises closed cell foam.

9. The sealing device according to claim 3, wherein the replaceable seal exterior surfaces of the first replaceable compliant sealing member are configured to contact the developer roller, the squeegee roller, the cleaner roller, and the one of the end cap members.

10. The sealing device according to claim 4, wherein the seal exterior surfaces of the second compliant sealing member are configured to contact the squeegee roller, the cleaner roller, and the one of the end cap members.

11. An ink developer unit, comprising:
a housing unit;
a plurality of rollers rotatably attached to the housing unit;
a plurality of end cap members of the housing unit to support at least one roller of the plurality of rollers; and
at least one sealing device disposed within the housing unit in an installed state, the at least one sealing device including:
a first replaceable compliant sealing member having a plurality of replaceable seal exterior surfaces to form a seal between a first set of rollers of the plurality of rollers and one of the end cap members;
a latch member having a closed state to maintain a sealing force on the first replaceable compliant sealing member and an open state to remove the sealing force on the first replaceable complaint sealing member; and
a second compliant sealing member having a plurality of seal exterior surfaces to form a seal between a second set of rollers of the plurality of rollers and the one of the end cap members.

12. The ink developer unit according to claim 11, wherein the first replaceable compliant sealing member and the second compliant sealing member further comprise closed cell foam.

13. The ink developer unit according to claim 11, further comprising an adhesive in contact with the housing unit and a portion of the seal exterior surfaces of the second compliant sealing member, the adhesive to couple the second complaint sealing member to the housing unit.

14. The ink developer unit according to claim 11, wherein the first set of rollers comprises:
a developer roller configured to supply a film of ink to be selectively transferred to a photoconductive drum;
a squeegee roller configured to compact the ink on the developer roller to form a uniform layer thereon; and
a cleaner roller configured to remove access ink remaining on the developer roller and not previously transferred to the photoconductive drum.

15. The ink developer unit according to claim 14, wherein the developer roller further comprises:
a replaceable developer roller

16. The ink developer unit according to claim 14, wherein the second set of rollers comprises the squeegee roller and the cleaner roller.

17. The ink developer unit according to claim 11, further comprising:
a channel disposed within the housing unit configured to provide ink to one roller of the plurality of rollers.

18. The ink developer unit according to claim 17, wherein the seal formed by the replaceable seal exterior surfaces of the first replaceable compliant sealing member is configured to limit an unwanted flow of ink from inside to outside of the housing unit and wherein the seal formed by the seal exterior surfaces of the second compliant sealing member is configured to limit the unwanted flow of ink from the inside to the outside of the housing unit.

19. The ink developer unit according to claim 11, wherein the at least one sealing device comprises a pair of sealing devices.

20. An ink developer unit, comprising:
a housing unit;
a plurality of rollers rotatably attached to the housing nit;
a plurality of end cap members of the housing unit to support at least one of the plurality of rollers;
a channel disposed within the housing unit configured to provide ink to one of the rollers; and
a pair of sealing devices disposed within the housing unit in an installed state, each one of the pair of sealing devices including:
a first replaceable compliant sealing member having a plurality of replaceable seal exterior surfaces to form a seal between a first set of rollers of the plurality of rollers and one of the end cap members;
a latch member including a cam portion, the latch member to maintain a sealing force on the first replaceable compliant sealing member in the closed state and to remove the sealing force on the first replaceable complaint sealing member in the open state; and
a second compliant sealing member having a plurality of seal exterior surfaces to form a seal between a second set of rollers of the plurality of rollers and the one of the end cap members; and
wherein the first replaceable compliant sealing member and the second compliant sealing member include closed cell foam.
